(19) United States
(12) Patent Application Publication
(10) Pub. No.: US 2020/0187436 A1
(43) Pub. Date: Jun. 18, 2020

(54) Combined Intelligent Recyclable Planting Device

(71) Applicant: Man Lei CHING, Hong Kong (HK)

(72) Inventor: Man Lei CHING, Hong Kong (HK)

(21) Appl. No.: 16/248,748

(22) Filed: Jan. 15, 2019

(30) Foreign Application Priority Data
Dec. 17, 2018 (CN) 201811539990.0

(51) Int. Cl. A01G 27/00; A01G 9/02; A01G 7/04

(52) U.S. Cl. CPC A01G 27/003; A01G 27/008; A01G 7/045; A01G 9/023

(57) ABSTRACT

The invention relates to a combined intelligent recyclable planting device which includes a bracket, a plurality of planting baskets arranged on the bracket and a circulation mechanism. The bracket includes a base plate, a plurality of vertical support rods and a plurality of lateral support rods. The vertical support rod is composed of a plurality of expansion joints. The planting basket includes an outer basket disposed on the lateral support rod, and an inner basket disposed in the inner cavity of the outer basket. The circulation mechanism includes a filter control box and a water storage tank. The filter control box is provided with a filter, a first water pump, an air pump and a controller. The water tank box is provided with a float liquid level switch and a second water pump. The combined intelligent recyclable planting device has simple and reasonable structure, easy to use, convenient disassembly and assembly, and high degree of intelligence. It does not pollute the planting environment, is not limited by the light intensity of the site, and can freely change the planting area, etc. It can effectively solve the problem that vegetable cultivation is limited by the planting environment.

### FIELD OF THE INVENTION

The invention relates to smart home equipment, in particular, a combined intelligent recyclable planting device.

### BACKGROUND

Nowadays, with the strengthening of people's health concept, pollution-free green organic vegetables grown on limited terraces such as their own balconies and roofs are gradually loved by people. However, this vegetable cultivation method is often carried out on several single-layer containers. The method of planting vegetables is limited by the site and the yield is not high, and all the watering and fertilization need manual operation, which requires operators to possess a certain planting technology foundation. Water or fertilizer easily seeps from the bottom of the planting container, causing pollution to the planting site. The planting site also requires to have good lighting conditions for the normal growth of vegetables, and not all sites are suitable for growing vegetables in this way.

### SUMMARY OF THE INVENTION

The technical problem to be solved is to overcome the above-mentioned deficiency by providing a combined intelligent recyclable planting device which has simple and reasonable structure, easy to use, convenient disassembly and assembly, and high degree of intelligence. It does not pollute the planting environment, is not limited by the light intensity of the site, and can freely change the planting area, etc. It can effectively solve the problem that vegetable cultivation is limited by the planting environment.

The technical solution of the present invention is to provide a combined intelligent recyclable planting device which includes a bracket, a plurality of planting baskets arranged on the bracket and a circulation mechanism. The bracket includes a base plate, a plurality of vertical support rods arranged on one side of the base plate in parallel, and a plurality of lateral support rods arranged on the vertical support rods.

The vertical support rod is composed of a plurality of expansion joints, and the upper end of the expansion joint is provided with a connecting sleeve having the same shape and size as the inner cavity of lower end of the adjacent expansion joint. The expansion joint and the connecting sleeve have a hollow structure. The expansion joint and the connecting sleeve are provided with a through groove communicated with the expansion joint and connected to the inner cavity of the connecting sleeve.

The bottom of the inner cavity of the vertical support rod is fixedly provided with a motor, and a lead screw connected to the motor arranged in the longitudinal direction.

One end of the lateral support rod is provided with a slider which is slidably connected with the expansion joint and the inner cavity of the connecting sleeve, and the other end of the lateral support rod protrudes from the through groove. A plurality of auxiliary supports are arranged between the other end of the lateral support rod and the adjacent lateral support rod. The lead screw is threadedly connected to the slider.

The planting basket includes an outer basket disposed on the lateral support rod, and an inner basket disposed in the inner cavity of the outer basket. The bottom of the inner cavity of the outer basket is provided with a first temperature and humidity sensor, an ultrasonic transducer and a sewer pipe. A support rod of inner basket is horizontally disposed between the side walls of inner cavity of the outer basket. A lifting cylinder is vertically disposed between the side walls of inner cavity of the outer basket.

The bottom of the inner basket abuts the support rod of inner basket. The flange of the open end of the inner basket abuts the lifting cylinder. The bottom of the open end of the inner basket is inlaid with a second temperature and humidity sensor and illumination sensor.

The circulation mechanism includes a filter control box fixedly disposed on the base plate and a water storage tank. The filter control box is provided with a filter connected to the sewer pipe, and a first water pump whose two ends are connected to the filter and the water storage tank respectively, an air pump and a controller connected to the lifting cylinder. The water storage tank is provided with a float liquid level switch and a second water pump.

Further, the bottom of the base plate is evenly provided with a plurality of universal wheels with a locking mechanism.

Further, the bottom of the outer basket is provided with a groove that is engaged with the lateral support rod and the auxiliary support rod.

Further, the inner basket is provided with a plurality of through holes.

Further, the detecting end of the first temperature and humidity sensor protrudes into the inner cavity of the inner basket.

Further, the auxiliary support rod is provided with a distance sensor whose detection end is vertically downward, an auxiliary illumination lamp, and an atomizing nozzle connected to the second water pump.

Further, the controller is respectively electrically connected to the motor, the first temperature and humidity sensor, the ultrasonic transducer, the second temperature and humidity sensor, the illumination sensor, the first water pump, the air pump, the float liquid level switch, the distance sensor, the auxiliary illumination lamp and the second water pump.

Further, the expansion joint and the connecting sleeve are vertically provided with a through groove, and the through groove extends from one end of the connecting sleeve, but the length thereof is shorter than the length of connection of the expansion joint and the connecting sleeve.

The technical effect of the present invention is to provide a combined intelligent recyclable planting device, which includes a bracket, a planting basket and a circulation mechanism. The brackets can be freely combined into a plurality of mutually supported support racks, and the planting baskets are respectively arranged on the support racks. The brackets can adjust the distance between the planting baskets by manual or electrical means with the growing height of the plants. Various environmental sensors are arranged in the planting basket to adjust the plant growth environment to the most by detecting the growth environment of the plants and by means of auxiliary lighting, atomizing nozzles and the like. The circulation mechanism will collect and treat the seeped water and fertilizer, and recycle it without polluting the planting environment. The combined intelligent recyclable planting device has simple and reasonable structure, easy to use, convenient disassembly and assembly, and high degree of intelligence. It does not pollute the planting environment, is not limited by the light intensity of the site, and can freely change the planting area, etc. It can effectively solve the problem that vegetable cultivation is limited by the planting environment.

### BRIEF DESCRIPTION OF THE DRAWINGS

The invention is illustrated by the following figures and embodiments.

FIG. 1 shows a schematic diagram of whole structure of a combined intelligent recyclable planting device in accordance with an example embodiment.

FIG. 2 shows a schematic diagram of a bracket of a combined intelligent recyclable planting device in accordance with an example embodiment.

FIG. 3 shows a schematic diagram of an expansion joint of a combined intelligent recyclable planting device in accordance with an example embodiment.

FIG. 4 shows a schematic diagram of cross-section of a planting basket of a combined intelligent recyclable planting device in accordance with an example embodiment.

FIG. 5 shows a schematic diagram of an outer basket of a combined intelligent recyclable planting device in accordance with an example embodiment.

FIG. 6 shows a schematic diagram of a water storage tank of a combined intelligent recyclable planting device in accordance with an example embodiment.

FIG. 7 shows a schematic diagram of inside structure of a filter control box of a combined intelligent recyclable planting device in accordance with an example embodiment.

The reference numbers of the figures are as follows:

1: bracket; 11: base plate; 12: vertical support rod; 120: expansion joint; 121: through groove; 122: connecting sleeve; 123: motor; 124: lead screw; 13: lateral support rod; 130: distance sensor; 131: auxiliary illumination lamp; 132: atomizing nozzle; 133: auxiliary support rod; 134: slider; 14: universal wheels; 2: planting basket; 21: outer basket; 211: first temperature and humidity sensor; 212: ultrasonic transducer; 213: support rod of inner basket; 214: sewer pipe; 215: lifting cylinder; 216: groove; 22: inner basket; 221: through hole; 222: illumination sensor; 223: second temperature and humidity sensor; 3: circulation mechanism; 31: filter control box; 311: filter; 312: first water pump; 313: air pump; 314: controller; 32: water storage tank; 321: second water pump; 322: float liquid level switch.

### DETAILED DESCRIPTION

The invention is illustrated in accordance with figures. The figures as simplified diagrams demonstrate the basic structures of the apparatus of embodiments of the invention. Thus; the invention is not limited to the figures.

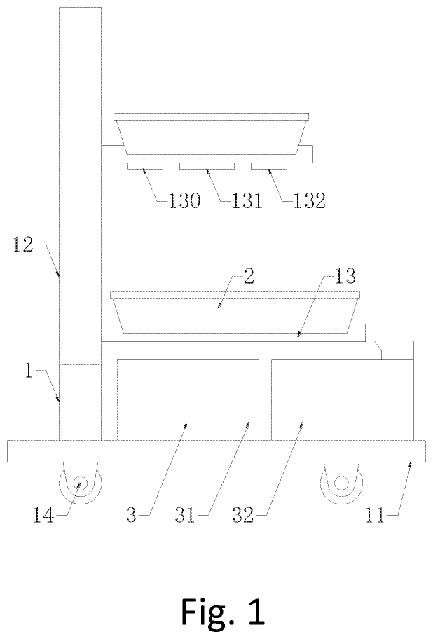

As shown in FIG. 1, a combined intelligent recyclable planting device includes a bracket 1, a plurality of planting baskets 2 arranged on the bracket 1 and a circulation mechanism 3.

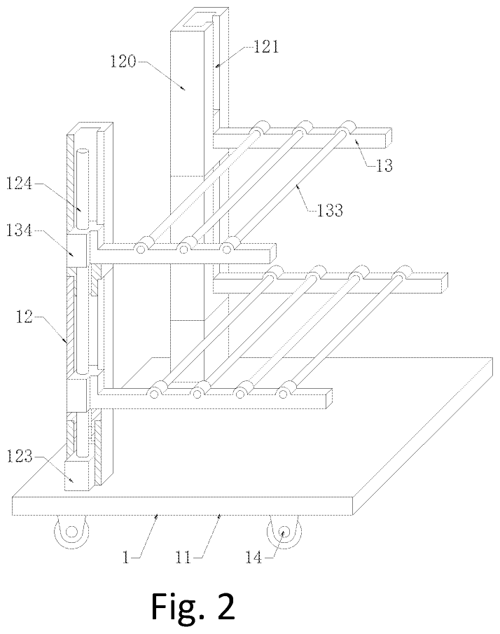

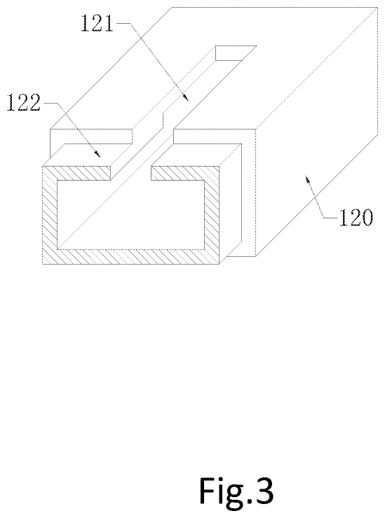

As shown in FIGS. 2 and 3, the bracket 1 includes a base plate 11, a plurality of vertical support rods 12 arranged on one side of the base plate 11 in parallel, and a plurality of lateral support rods 13 arranged on the vertical support rods 12.

The vertical support rod 12 is composed of a plurality of expansion joints 120, and the upper end of the expansion joint 120 is provided with a connecting sleeve 122 having the same shape and size as the inner cavity of lower end of the adjacent expansion joint 120. The expansion joint 120 and the connecting sleeve 122 have a hollow structure. In other words, one end of the same expansion joint 120 is provided with a connecting sleeve 122, and the outer shape and outer shape of the connecting sleeve 122 are the same as the inner cavity structure at the other end of the expansion joint 120.

The expansion joint 120 and the connecting sleeve 122 are provided with a through groove 121 communicated with the expansion joint and connected to the inner cavity of the connecting sleeve.

The bottom of the inner cavity of the vertical support rod 12 is fixedly provided with a motor 123, and a lead screw 124 connected to the motor 123 arranged in the longitudinal direction. The lead screw 124 is composed of a plurality of short screws, and the short screws are connected to each other by an electromagnetic clutch.

One end of the lateral support rod 13 is provided with a slider 134 which is slidably connected with the expansion joint 120 and the inner cavity of the connecting sleeve 122, and the other end of the lateral support rod 13 protrudes from the through groove. A plurality of auxiliary supports 133 are arranged between the other end of the lateral support rod 13 and the adjacent lateral support rod 13. The lead screw 124 is threadedly connected to the slider 134. The distance between the lateral support rods 13 is conveniently adjusted by the lead screw 124 by the driving connection with the slider 134. For example, If it is necessary to increase the distance between the second planting basket 2 and the top planting basket 2 counted from the top to the bottom, the planting basket 2 is first raised relative to the ground, then the connection of the topmost lateral support rod 13 to the motor 123 is disconnected, and the planting baskets 2 except for the top planting basket is moved downward, and so on. If it is necessary to reduce the distance between the top planting basket 2 and the second planting basket 2 counted from the top to the bottom, first disconnecting the top lateral support rod 13 from the motor 123, and then lifts the planting baskets 2 except the top planting basket 2 and so on.

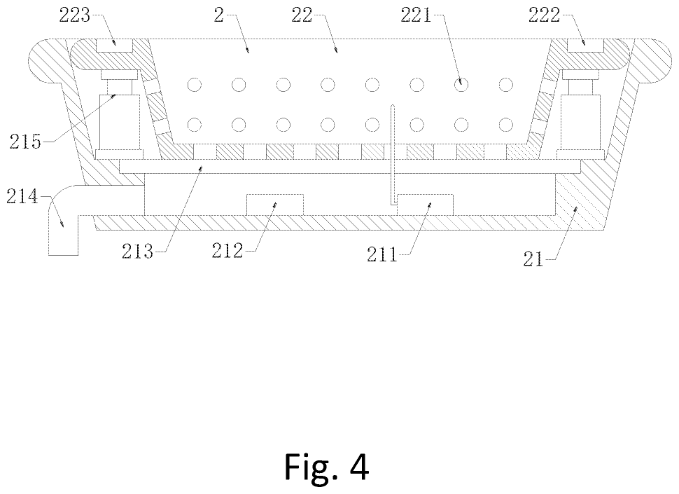

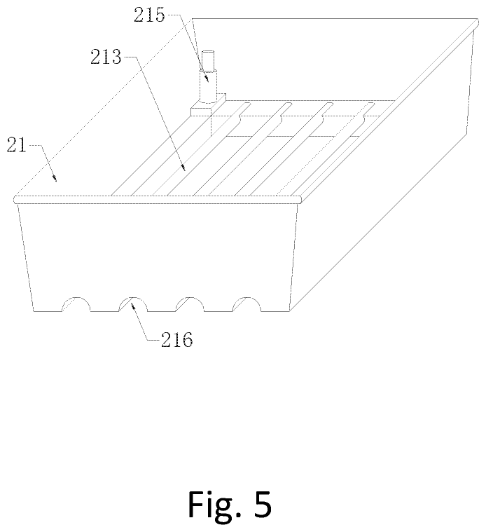

As shown in FIGS. 4 and 5, the planting basket 2 includes an outer basket 21 disposed on the lateral support rod 13, and an inner basket 22 disposed in the inner cavity of the outer basket 21. The bottom of the inner cavity of the outer basket 21 is provided with a first temperature and humidity sensor 211 for detecting the temperature and the humility of soil, an ultrasonic transducer for atomizing water and fertilizer for humidifying and fertilizing the bottom of the soil, and a sewer pipe 214 for collecting oozing liquid. A support rod of inner basket 213 is horizontally disposed between the side walls of inner cavity of the outer basket 21. A lifting cylinder 215 is vertically disposed between the side walls of inner cavity of the outer basket 22.

The bottom of the inner basket 22 abuts the support rod of inner basket 213. The flange of the open end of the inner basket 22 abuts the lifting cylinder 215. The bottom of the open end of the inner basket 22 is inlaid with a second temperature and humidity sensor 223 for detecting the temperature and the humidity of outside environment and an illumination sensor 222 for detecting light intensity.

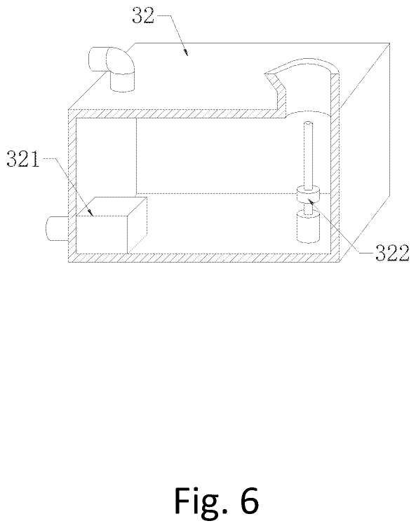

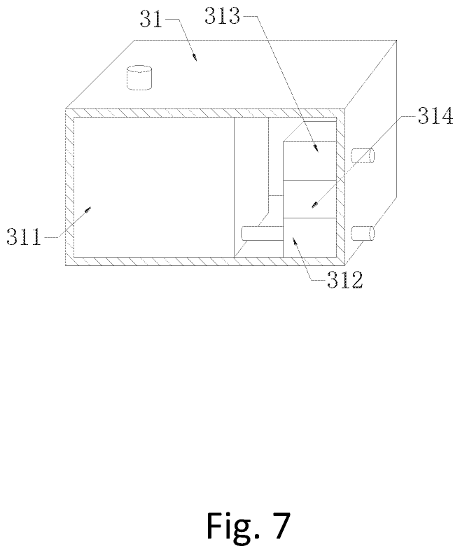

As shown in FIGS. 1, 6 and 7, the circulation mechanism 3 includes a filter control box 31 fixedly disposed on the base plate 11 and a water storage tank 32. The filter control box 31 is provided with a filter 311 connected to the sewer pipe 214, and a first water pump 213 whose two ends are connected to the filter 311 and the water storage tank 32 respectively, an air pump 313 and a controller 314 connected to the lifting cylinder 215. The water storage tank 32 is provided with a float liquid level switch 322 and a second water pump 321.

In an example embodiment as shown in FIG. 1, the bottom of the base plate 11 is evenly provided with a plurality of universal wheels with a locking mechanism to facilitate to handle and adjust for short distance.

In an example embodiment as shown in FIG. 5, the bottom of the outer basket 21 is provided with a groove 216 that is engaged with the lateral support rod 13 and the auxiliary support rod 133. In this way, the planting basket 2 is stabilized and prevents falling.

In an example embodiment as shown in FIG. 4, the inner basket 21 is provided with a plurality of through holes 221. The through holes 221 are mainly used for soil ventilation, and are beneficial to the atomized water and fertilizer at the bottom of the inner basket 22 to enter the soil interior.

In an example embodiment as shown in FIG. 4, the detecting end of the first temperature and humidity sensor 211 protrudes into the inner cavity of the inner basket 22 to better detect the temperature and humidity inside the soil.

In an example embodiment as shown in FIG. 1, the auxiliary support rod 133 is provided with a distance sensor 130 whose detection end is vertically downward and for detecting the distance between the bracket and the plants, an auxiliary illumination lamp 131 for increasing illumination, and an atomizing nozzle 132 connected to the second water pump 321 and for spraying to increase humidity.

In an example embodiment as shown in FIG. 3, the expansion joint 120 and the connecting sleeve 122 are vertically provided with a through groove 121, and the through groove 121 extends from one end of the connecting sleeve 122, but the length thereof is shorter than the length of connection of the expansion joint 120 and the connecting sleeve 122.

In the above example embodiments, the controller 314 is respectively electrically connected to the motor 123, the first temperature and humidity sensor 211, the ultrasonic transducer 212, the second temperature and humidity sensor 223, the illumination sensor 222, the first water pump 312, the air pump 313, the float liquid level switch 322, the distance sensor 130, the auxiliary illumination lamp 131 and the second water pump 321.

The combined intelligent recyclable planting device of the present invention has a reasonable structure which includes a bracket, a planting basket and a circulation mechanism. The brackets can be freely combined into a plurality of mutually supported support racks, and the planting baskets are respectively arranged on the support racks. The brackets can adjust the distance between the planting baskets by manual or electrical means with the growing height of the plants. Various environmental sensors are arranged in the planting basket to adjust the plant growth environment to the most by detecting the growth environment of the plants and by means of auxiliary lighting, atomizing nozzles and the like. The circulation mechanism will collect and treat the seeped water and fertilizer, and recycle it without polluting the planting environment. The combined intelligent recyclable planting device has simple and reasonable structure, easy to use, convenient disassembly and assembly, and high degree of intelligence. It does not pollute the planting environment, is not limited by the light intensity of the site, and can freely change the planting area, etc. It can effectively solve the problem that vegetable cultivation is limited by the planting environment.

The exemplary embodiments of the present invention are thus fully described. Although the description referred to particular embodiments; it will be clear to one skilled in the art that the present invention may be practiced with variations of these specific details. Hence this invention should not be construed as limited to the embodiments set forth herein.

1. A combined intelligent recyclable planting device, comprising: a bracket 1, a plurality of planting baskets 2 arranged on the bracket 1 and a circulation mechanism 3, wherein the bracket 1 includes a base plate 11, a plurality of vertical support rods 12 arranged on one side of the base plate 11 in parallel, and a plurality of lateral support rods 13 arranged on the vertical support rods 12,
wherein the vertical support rod 12 is composed of a plurality of expansion joints 120, and the upper end of the expansion joint 120 is provided with a connecting sleeve 122 having the same shape and size as the inner cavity of lower end of the adjacent expansion joint 120; the expansion joint 120 and the connecting sleeve 122 have a hollow structure; the expansion joint 120 and the connecting sleeve 122 are provided with a through groove 121 communicated with the expansion joint and connected to the inner cavity of the connecting sleeve,
wherein the bottom of the inner cavity of the vertical support rod 12 is fixedly provided with a motor 123, and a lead screw 124 connected to the motor 123 arranged in the longitudinal direction,
wherein one end of the lateral support rod 13 is provided with a slider 134 which is slidably connected with the expansion joint 120 and the inner cavity of the connecting sleeve 122, and the other end of the lateral support rod 13 protrudes from the through groove; a plurality of auxiliary supports 133 are arranged between the other end of the lateral support rod 13 and the adjacent lateral support rod 13; the lead screw 124 is threadedly connected to the slider 134,
wherein the planting basket 2 includes an outer basket 21 disposed on the lateral support rod 13, and an inner basket 22 disposed in the inner cavity of the outer basket 21; the bottom of the inner cavity of the outer basket 21 is provided with a first temperature and humidity sensor 211, an ultrasonic transducer, and a sewer pipe 214; a support rod of inner basket 213 is horizontally disposed between the side walls of inner cavity of the outer basket 21; a lifting cylinder 215 is vertically disposed between the side walls of inner cavity of the outer basket 22,
wherein the bottom of the inner basket 22 abuts the support rod of inner basket 213; the flange of the open end of the inner basket 22 abuts the lifting cylinder 215; the bottom of the open end of the inner basket 22 is inlaid with a second temperature and humidity sensor 223 and an illumination sensor 222,
wherein the circulation mechanism 3 includes a filter control box 31 fixedly disposed on the base plate 11 and a water storage tank 32; the filter control box 31 is provided with a filter 311 connected to the sewer pipe 214, and a first water pump 213 whose two ends are connected to the filter 311 and the water storage tank 32 respectively, an air pump 313 and a controller 314 connected to the lifting cylinder 215; the water storage tank 32 is provided with a float liquid level switch 322 and a second water pump 321.

2. The combined intelligent recyclable planting device of claim 1, wherein the bottom of the base plate 11 is evenly provided with a plurality of universal wheels with a locking mechanism.

3. The combined intelligent recyclable planting device of claim 1, wherein the bottom of the outer basket 21 is provided with a groove 216 that is engaged with the lateral support rod 13 and the auxiliary support rod 133.

4. The combined intelligent recyclable planting device of claim 1, wherein the inner basket 21 is provided with a plurality of through holes 221.

5. The combined intelligent recyclable planting device of claim 1, wherein the detecting end of the first temperature and humidity sensor 211 protrudes into the inner cavity of the inner basket 22.

6. The combined intelligent recyclable planting device of claim 1, wherein the auxiliary support rod 133 is provided with a distance sensor 130 whose detection end is vertically downward, an auxiliary illumination lamp 131, and an atomizing nozzle 132 connected to the second water pump 321.

7. The combined intelligent recyclable planting device of claim 1, wherein the controller 314 is respectively electrically connected to the motor 123, the first temperature and humidity sensor 211, the ultrasonic transducer 212, the second temperature and humidity sensor 223, the illumination sensor 222, the first water pump 312, the air pump 313, the float liquid level switch 322, the distance sensor 130, the auxiliary illumination lamp 131 and the second water pump 321.

8. The combined intelligent recyclable planting device of claim 1, wherein the expansion joint 120 and the connecting sleeve 122 are vertically provided with a through groove 121, and the through groove 121 extends from one end of the connecting sleeve 122, but the length thereof is shorter than the length of connection of the expansion joint 120 and the connecting sleeve 122.

9. The combined intelligent recyclable planting device of claim 6, wherein the controller 314 is respectively electrically connected to the motor 123, the first temperature and humidity sensor 211, the ultrasonic transducer 212, the second temperature and humidity sensor 223, the illumination sensor 222, the first water pump 312, the air pump 313, the float liquid level switch 322, the distance sensor 130, the auxiliary illumination lamp 131 and the second water pump 321.
